(19) United States
(12) Patent Application Publication
(10) Pub. No.: US 2025/0252815 A1
(43) Pub. Date: Aug. 7, 2025

(54) Geolocation Services For Online Gambling

(71) Applicant: XPOINT SERVICES LLC, Miami Beach, FL (US)

(72) Inventors: Simon Volman, Dubai (AE); Artemy Nazin, Dubai (AE); Benjamin Cheeseman, Dubai (AE)

(21) Appl. No.: 18/431,336

(22) Filed: Feb. 2, 2024

(51) Int. Cl. G07F 17/32

(52) U.S. Cl. CPC G07F 17/3239

(57) ABSTRACT

A method for geolocation monitoring that includes obtaining an initiating command from a device and obtaining geolocation information of the device to determine whether an initial location of the device is an approved location. The method also includes, responsive to determining that the device is located at an approved location, determining whether a network connection of the device is static and whether a device type is a desktop device or a mobile device. Responsive to determining whether the network connection of the device is static and whether the device type is a desktop device or a mobile device, the method further includes selecting a geolocation tracking mode for the device to determine subsequent locations of the device based on obtaining the geolocation information of the device.

### TECHNICAL FIELD

This disclosure relates to geolocation services, and more particularly, to geolocation services employed for online gambling to monitor a location of a user.

### BACKGROUND

State legislative changes and the rise in popularity of online gambling has led to an increase in gambling applications, providing users with convenient and accessible platforms for various types of gambling. To ensure the integrity of these platforms and to comply with regulatory requirements, many jurisdictions may require strict geolocation monitoring and/or control to restrict access to users within authorized regions. For example, a state may require geolocation monitoring and/or control to restrict access to users within the regional boundaries of the state, thereby preventing users from partaking in online gambling across state lines, whereby a neighboring state may have different regulatory requirements and/or may prohibit online gambling altogether.

Various methods of geolocation services may be used to monitor users of online gambling applications. For example, the online gambling applications may utilize a standard Global Positioning System (GPS) and/or internet protocol (IP) address tracking of a user's personal electronic device.

### SUMMARY

In one aspect of the present disclosure, a method of geolocation monitoring is disclosed. The method includes obtaining an initiating command from a device and obtaining geolocation information of the device to determine whether an initial location of the device is an approved location. The method also includes, responsive to determining that the device is located at an approved location, determining whether a network connection of the device is static and whether a device type is a desktop device or a mobile device. Responsive to determining whether the network connection of the device is static and whether the device type is a desktop device or a mobile device, the method further includes selecting a geolocation tracking mode for the device to determine subsequent locations of the device based on obtaining the geolocation information of the device.

The geolocation tracking mode may establish a time interval for determining the subsequent locations of the device. The geolocation tracking mode may be a trust mode or a normal mode, and the time interval established in the trust mode may be equal to or longer than the time interval established in the normal mode. The method may also include, responsive to determining that the network connection of the device is static, and the device type is a mobile device, selecting the trust mode to determine the subsequent locations of the device. Additionally, the method may include, responsive to determining that the network connection is not static, selecting the normal mode to determine the subsequent locations of the device. Moreover, the method may include, responsive to determining that the initial location of the device is located at an approved location, determining whether the trust mode is enabled for a region in which the device is located.

Determining whether the network connection of the device is static may include determining whether an internet protocol (IP) address of the device is residential or business, and determining whether the IP address of the device is mobile. Determining whether the network connection of the device is static may further include obtaining, from a database, whether the IP address of the device is categorized as a wireless IP address.

The method may also include, responsive to determining that the device type is a mobile device, determining whether the device is static. Determining whether the device is static may be based on speed data from the device.

The method may also include, responsive to determining that the device type is a desktop device, determining whether location signals of the device are from an approved location. The location signals of the device may include at least one of an IP address of the device, Wi-Fi network information of the device, and other location-related information provided by the device.

In another aspect of the present disclosure, a system is disclosed. The system includes a device configured to provide access of an online gambling application to a user and a geolocation processing server. The geolocation processing server is configured to obtain an initiating command from the device and obtain geolocation information of the device to determine whether an initial location of the device is located at an approved location. Responsive to determining that the device is located at an approved location, the geolocation processing server is further configured to determine whether a network connection of the device is static and determine whether a device type is a desktop device or a mobile device. Additionally, responsive to determining whether the network connection of the device is static and whether the device type is a desktop device or a mobile device, the geolocation processing server is further configured to establish a time interval to determine subsequent locations of the device based on obtaining the geolocation information of the device.

Responsive to determining that the device is not located at an approved location, the geolocation processing server may be further configured to deny permission of the user to access the online gambling application.

Responsive to determining that the network connection of the device is static and the device type is a mobile device, the geolocation processing server may be further configured to determine whether the device is static based on speed data obtained from the device. Additionally, responsive to determining that the device is static, the geolocation processing server may be further configured to establish the time interval to determine subsequent locations of the device such that the time interval established is greater than a time interval established when the device is not static.

Responsive to determining that the network connection of the device is static and the device type is a desktop device, the geolocation processing server may be further configured to determine whether location signals of the device are from an approved location. Additionally, responsive to determining that the location signals of the device are from an approved location, the geolocation processing server may be further configured to establish the time interval to determine subsequent locations of the device such that the time interval established is greater than a time interval established when the location signals of the device are not from an approved location.

The geolocation process service may be further configured to modify the time interval established based on one or more conditions. The one or more conditions may include at least one of: the network connection of the device changes; the device moves; and a scheduled time period passes for reevaluation of the time interval.

In another aspect of the present disclosure, a method for determining operation of an online gambling application using geolocation information of a device is disclosed. The method includes, obtaining, from the device, an initiating command that corresponds to a user interaction with the online gambling application via a user interface of the device. The method also includes obtaining geolocation information of the device to determine whether an initial location of the device is within an approved region for use of the online gambling application. Additionally, the method includes, responsive to determining that the initial location of the device is within the approved region, determining whether a network connection of the device is static and determining whether a device type is a desktop device or a mobile device. The method further includes selecting a geolocation tracking mode for the device based on the network connection of the device and the device type, wherein the geolocation tracking mode establishes a time interval for determining subsequent locations of the device based on obtaining the geolocation information of the device.

Responsive to determining that the network connection of the device is static and the device type is a mobile device, the method may further include determining whether the device is static based on speed data obtained from the device. Responsive to determining that the network connection of the device is static and the device type is a desktop device, the method may further include determining whether location signals of the device are from an approved location. The location signals of the device may include at least one an IP address of the device, Wi-Fi network information of the device, and other location-related information provided by the device. Additionally, the geolocation track mode may be a trust mode or a normal mode, and the time interval established in the trust mode may be equal to or longer than the time interval established in the normal mode. Additionally, responsive to determining that the initial location of the device is within the approved region for use of the online gambling application, the method may further include determining whether the trust mode is enabled for the approved region.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is an example of an environment for determining geolocation services in accordance with embodiments of this disclosure.

FIG. 2 is a block diagram of an example of a system that implements geolocation services.

FIG. 3 is a block diagram of an example of a device in accordance with embodiments of this disclosure.

FIG. 4 is a flow diagram of an example of a process for implementing geolocation services for online gambling.

FIG. 5A is a flow diagram of an example of a process for implementing geolocation services for online gambling.

FIG. 5B is a continuation of the flow diagram of FIG. 5A illustrating the process for implementing geolocation services for online gambling.

FIG. 6 is a flow diagram of an example of a method for implementing geolocation services for online gambling.

### DETAILED DESCRIPTION

The present disclosure relates to geolocation services, such as geolocation services utilized to determine a geographic location of an electronic device. The electronic device may be any type of electronic device, such as a personal electronic device including, but not limited to, a mobile cellular device, a laptop, a desktop, and a tablet. That is, geolocation services as described herein may generally apply to any electronic device and are not particularly limited to any one such device.

Typical geolocation services may be utilized to track a geographic location of an electronic device to control access to one or more features of the electronic device or to provide targeted information to be displayed on the electronic device based on the geographic location of the electronic device. Geolocation services may be utilized to permit and/or restrict access to one or more applications stored or otherwise accessed through the electronic device. For example, geolocation services may be utilized to determine the geographic location of the electronic device such that, if the electronic device is located outside of an approved region, the electronic device may be restricted from using an application stored or otherwise accessed through the electronic device.

As described above, geolocation services may be implemented in a variety of manners to monitor activity of electronic devices. By way of example, geolocation services may be implemented to monitor the use of online gambling applications. A user may access the online gambling applications through the electronic device (e.g., a personal mobile phone or tablet), whereby activity of the user within the gambling applications may be monitored to determine a geographic location of such activity. That is, the geolocation services may determine a location of the electronic device when the user uses the gambling applications. As a result, the geolocation services may restrict and/or permit access to the gambling applications based upon whether the electronic device is located in an approved region or in a restricted region.

Typical geolocation services for gambling applications may utilize a standard Global Positioning System (GPS) and/or internet protocol (IP) address tracking of a user's personal electronic device to ensure that the user's actions within the gambling applications are approved for a given location of the electronic device. For example, while one state may permit online gambling within its regional boundaries (i.e., may permit online gambling within said state), neighboring states may prohibit such online gambling. As a result, geolocation services may be required to ensure that any actions taken through the gambling applications (e.g., placing a sports bet or partaking in a game through the gambling applications) are done within the online gambling approved state and not within a prohibited neighboring state.

In a conventional manner, geolocation services may be implemented in the above scenario by checking the user's location (e.g., a location of the personal electronic device of the user) at set time intervals based on a proximity to a defined area, such as a state border. The set time intervals may be decreased (i.e., shorter) when the user is near the state border or other defined area compared to if the user were to be located centrally within the state. As a result, the user's location may be checked more frequently when the user is near the defined area (e.g., the state border) irrespective of any other factors, thereby requiring increased computing resources of the user's personal electronic device and potentially impairing the user's experience within the gambling applications. Similarly, the increased frequency of checking the user's location may also lead to increased battery consumption of the user's personal electronic device. For example, if the user lives near the border, the user's location may be checked more frequently through the user's personal electronic device, thereby inhibiting the overall performance of the online gambling application and negatively impacting the user's experience.

Implementations of this disclosure address problems such as these by providing dynamic geolocation services. The dynamic geolocation services may determine additional factors relating to a user's personal electronic device such that a defined time interval for checking the user's location may be adjusted based on the location of the user, based one or more additional factors, or both (e.g., not based solely on the location of the user's personal electronic device). It should be noted that the implementation of geolocation services for online gambling applications as described herein is only intended as an illustrative example. That is, implementations of the geolocation services described herein may be implemented for monitoring the location of an electronic device for any number of applications and/or uses, and such geolocation services are not limited to only online gambling applications.

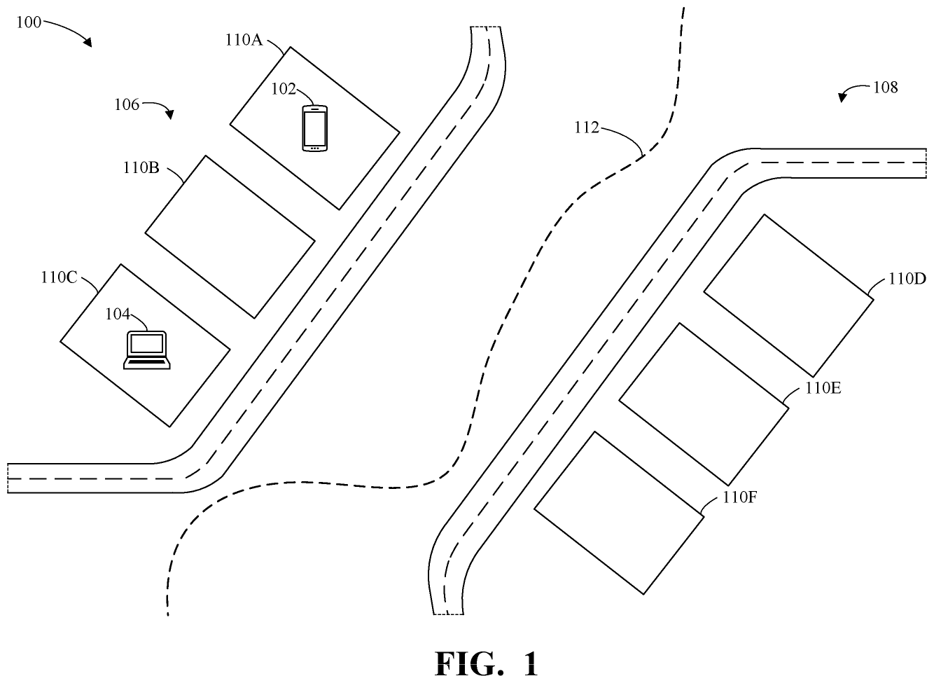

Turning now to the figures, FIG. 1 illustrates an example of an environment 100 for determining geolocation services in accordance with the embodiments of this disclosure. In particular, the geolocation services in accordance with the embodiments of this disclosure may be utilized to determine a location of one or more devices within the environment 100, such as a mobile cellular device 102 and/or a laptop 104. The geolocation services may be utilized to determine the location of the mobile cellular device 102 and/or the laptop 104 within the environment 100 in a dynamic manner such that, even if the mobile cellular device 102 and/or the laptop 104 move within the environment 100, the location of the mobile cellular device 102 and/or the laptop 104 may be determined in real-time. For example, as described above, the geolocation services may determine the location of the mobile cellular device 102 and/or the laptop 104 based on a set time interval.

The geolocation services may be implemented to determine the location of the mobile cellular device 102 and/or the laptop 104 to control access to one or more applications of the mobile cellular device 102 and/or the laptop 104, such as one or more applications stored on, or otherwise accessible through, the mobile cellular device 102 and/or the laptop 104. By way of example, the one or more applications may be an online gambling application downloaded and stored on the mobile cellular device 102 and/or the laptop 104 or an online gambling application accessible via a web browser of the mobile cellular device 102 and/or the laptop 104. In such a case, a user may place bets or partake in gambling via the mobile cellular device 102 and/or the laptop 104.

As noted above, the geolocation services described herein may be implemented to determine a location of the mobile cellular device 102 and/or the laptop 104 for any desired reason. For example, the geolocation services may be implemented to control access or permissions to one or more other types of applications (e.g., banking applications, video-streaming applications, music applications, etc.), to provide targeted content to the user through the mobile cellular device 102 and/or the laptop 104 (e.g., targeted ads, targeted search results in the surrounding area, etc.), to control one or more functions of the mobile cellular device 102 and/or the laptop 104 (e.g., to permit and/or restrict voice calls over a cellular network), or a combination thereof.

Turning back to the environment 100 shown in FIG. 1, access to the online gambling applications through the mobile cellular device 102 and/or the laptop 104 may be controlled based on a location of the mobile cellular device 102 and/or the laptop 104 determined using the geolocation services. As discussed above, online gambling may often be restricted by legislation. For example, legislation on a state-by-state basis may permit or restrict online gambling within each state and may determine one or more protocols as to how online gambling may operate within each state. Such legislation may also regulate online gambling on a federal level such that online gambling may be restricted outside of the United States. Similar restrictions or protocols may also be implemented in other countries or regions, and as such, the geolocation services herein may be implemented in the United States or other countries.

By way of example, the environment 100 illustrates that the mobile cellular device 102 and the laptop 104 are situated within different ones of the structures 110A-C located in a first region 106. The first region 106 may be a defined territory, state, country, or other region for purposes of utilizing geolocation services. For example, the mobile cellular device 102 and the laptop 104 may be located in two different houses (i.e., the structure 110A and the structure 110C, respectively) within a first state (i.e., the first region 106), whereby the first state may permit online gambling through the mobile cellular device 102 and the laptop 104. However, for purposes of illustration, a neighboring second state, such as a second region 108 containing the structures 110D-F, may prohibit or otherwise restrict online gambling. As a result, a location of the mobile cellular device 102 and the laptop 104 may be tracked to ensure that the mobile cellular device 102 and/or the laptop 104 do not move across a border 112 separating the first region 106 and the second region 108 when utilizing the online gambling applications. That is, based on the geolocation services, access to the online gambling applications may be prevented or restricted when the mobile cellular device 102 and/or the laptop 104 are located in the second region 108.

As discussed above, geolocation services may be implemented to check a location of the mobile cellular device 102 and the laptop 104 based on a set interval of time. The set interval of time may often be determined by regulation, such as state legislation and/or regulation. Additionally, the set interval of time may often be decreased when the location of the mobile cellular device 102 and/or the laptop 104 are near a border, such as the border 112, compared to when the mobile cellular device 102 and/or the laptop 104 are centrally located within an approved region (e.g., the first region 106). As a result, using conventional geolocation tracking, a location of the mobile cellular device 102 and the laptop 104 may be checked more frequently near the border 112, thereby requiring additional resources and computing power of the mobile cellular device 102 and the laptop 104.

As discussed further herein, the geolocation services in accordance with embodiments of this disclosure may dynamically increase the above-referenced time interval for tracking the location of the mobile cellular device 102 and the laptop 104. For example, the geolocation services herein may determine whether the network connection of each of the devices and/or the devices themselves are static (i.e., remain stationary or unchanged). Based on such conditions, the geolocation services may maintain a longer interval of time for checking a location of the mobile cellular device 102 and the laptop 104, even if the mobile cellular device 102 and the laptop 104 are located near the border 112 as shown in the environment 100. Therefore, the location of the mobile cellular device 102 and the laptop 104 may be checked less frequently, thereby requiring less resources and computing power of the mobile cellular device 102 and the laptop 104.

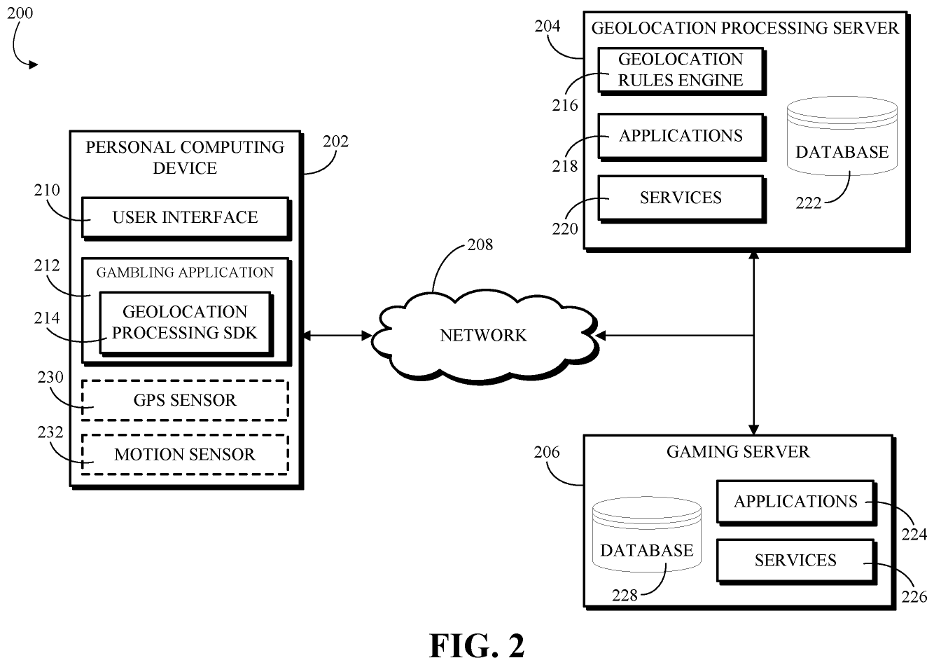

To describe some implementations of the geolocation services in accordance with the present teachings, reference is first made to examples of hardware and software structures used to implement the geolocation services. FIG. 2 is a block diagram of an example of a system 200 for electronic computing and communications that may implement the geolocation services herein.

The system 200 may be or may include a distributed computing system (e.g., a client-server computing system), a cloud computing system, a clustered computing system, or the like. The system 200 may include one or more computing devices, such as a personal computing device 202. As discussed above, the personal computing device 202 may be a mobile cellular device, a laptop, a desktop, a tablet, or the like. For example, the personal computing device 202 may be the mobile cellular device 102 or the laptop 104 shown in the environment 100. A user may access the system 200 through the personal computing device 202. The user may be a public entity or a private entity. By way of example, the user may be a private entity, such as a customer, that purchases or otherwise uses a gambling application 212. The gambling application 212 may be an online gambling application stored on, or otherwise accessible through, the personal computing device 202. Thus, the user may interface with the gambling application 212 through the personal computing device 202. It should be noted that an application other than the gambling application 212 may also be implemented in accordance with the present teachings. The user may access the gambling application 212 through a user interface 210 of the personal computing device 202. The user interface 210 may be any interface of the personal computing device 202, such as a touchscreen, a keyboard, a mouse, voice command, or a combination thereof.

As discussed above, the gambling application 212 may be an online gambling application that may be accessed through the personal computing device 202. The gambling application 212 may be an instance of software running on the personal computing device 202. The gambling application 212 may be stored directly on the personal computing device 202 or may be accessible via the personal computing device 202, such as through a web browser, whereby the user may access the gambling application 212 through a website. It should also be noted that any number of personal computing devices 202, and thus any number of users, may be possible in accordance with the system 200.

The personal computing device 202 may be in communication with one or more additional devices within the system 200. The personal computing device 202 may be in communication with a geolocation processing server 204 and/or a gaming server 206 of the system 200. The personal computing device 202 may be in wired or wireless communication with the geolocation processing server 204 and/or the gaming server 206.

The gaming server 206 may used for implementing services 226 (e.g., software services) related to the gambling application 212. That is, the gaming server 206 may be a computing system, which may include one or more computing devices, such as a desktop computer, a server computer, or another computer capable of operating as a server, or a combination thereof, that may be used to implement the services 226. As such, the services 226 may communicate with the personal computing device 202, such as through the gambling application 212, to share data with the personal computing device 202. The gaming server 206 may provide an overall architecture for online gambling, whereby the user may interface with the gambling application 212 to access the architecture of the online gambling. By way of example, using the user interface 210, the user may access the gambling application 212 to browse possible sports bets, whereby the bets are maintained, stored, and provided by the gaming server 206. As such, the user may place a bet through the gambling application 212 and the bet may be transmitted to the gaming server 206 for further tracking.

To facilitate the above activities, the gaming server 206 may include one or more databases, such as a database 228, and one or more applications 224. The database 228 may store any data associated with the online gambling architecture. For example, the database 228 may store information pertaining to future and past bets, user information, or both. Data stored on the database 228 may be accessed by the services 226 of the gaming server 206. As such, the gaming server 206 may run web-based software services deliverable to the user, such as through the gambling application 212 of the personal computing device 202. For example, the gaming server 206 may implement all or a portion of an online gambling platform based on information stored in the database 228, including communications software, messaging software, bet placing software, regulatory software, other gaming software, or a combination thereof. The online gambling platform may thus be at least partially accessed by the user via the gambling application 212.

The applications 224 of the gaming server 206 may be one or more applications run on the gaming server 206. The applications may provide an interface for service representatives to access the gaming server 206 and communicate directly or indirectly with the users. For example, the applications 224 may include a customer service application through which service representatives may access the online gaming platform (e.g., access the services 226 and/or the database 228 that may form the online gaming platform). As a result, the service representatives may support users through the gaming server 206 and communicate with the user via the gambling application 212. Thus, the gaming server 206 may provide a customer relationship management (CRM) system that may be integrated into, or in communication with, the overall online gaming platform to provide users of the gambling application 212 an improved customer experience.

As mentioned above, the system 200 may also include the geolocation processing server 204. The geolocation processing server 204 may include hardware and/or a configuration similar to the gaming server 206. The geolocation processing server 204 may be used to determine a location of the personal computing device 202. The geolocation processing server 204 may monitor and track a location of the personal computing device 202 to directly or indirectly control access to the online gambling platform through the gambling application 212. That is, the geolocation processing server 204 may track a location of the personal computing device 202 to determine if the personal computing device 202 is located in an approved region, such as the first region 106 of the environment 100. Access and/or restriction to the online gambling platform may thus be based on the location of the personal computing device 202 determined by the geolocation processing server 204.

To determine a location of the personal computing device 202, the geolocation processing server 204 may include a geolocation rules engine 216. The geolocation rules engine 216 may be or may include software executable by the geolocation processing server 204 or one or more devices thereof. The software may be executable to enforce a set of rules or logic on incoming data or requests received by the geolocation processing server 204, such as incoming data and/or requests received from the personal computing device 202 and/or the gaming server 206. Thus, the geolocation rules engine 216 may be executable to automate decision-making based on predefined conditions established by the geolocation rules engine 216.

By way of example, the personal computing device 202 may transmit a location of the personal computing device 202 to the geolocation processing server based on data provided by a global positioning system (GPS) sensor 230 and/or a motion sensor 232 of the personal computing device 202, at which point the geolocation rules engine 216 may execute software to determine whether the location of the personal computing device 202 is acceptable for placing a bet through the gambling application 212. Similarly, the personal computing device 202 may transmit motion of the personal computing device 202 to the geolocation processing server based on the data provided by the GPS sensor 230 and/or the motion sensor 232. The geolocation processing server 204 may then perform one or more additional actions and/or communicate such a determination to the personal computing device 202 and/or the gaming server 206 to permit access to the user.

The geolocation processing server 204 may also include one or more databases, such as a database 222, and one or more services 220. The database 222 and the services 220 may be accessible and operable similar to the database 228 and the services 226 of the gaming server 206. The geolocation processing server 204 may be a computing system, which may include one or more computing devices, such as a desktop computer, a server computer, or another computer capable of operating as a server, or a combination thereof, that may be used to implement the services 220. The services 220 may be web-based software services implemented by the geolocation processing server 204 that may be deliverable to the user via the personal computing device 202 through the gambling application 212.

The services 220 may be executable to track a location of the personal computing device 202. For example, the services 220 may be executable to establish a time interval for tracking the location of the personal computing device 202. The services 220 may establish such a time interval based on one or more determinations of the geolocation rules engine 216 (e.g., based upon data received from the personal computing device 202). Similarly, the database 222 may store data pertaining to permitted locations for the personal computing device 202. For example, the database 222 may store approved Internet Protocol (IP) addresses such that the services 220 may quickly access the stored IP addresses and determine if an IP address associated with the personal computing device 202 or a network associated with the personal computing device 202 is approved.

As discussed in further detail below, the geolocation processing server 204 may communicate with the personal computing device 202 and may receive data from the personal computing device 202 or components thereof (e.g., the GPS sensor 230 and/or the motion sensor 232) to determine the location of the personal computing device 202. For example, the personal computing device 202 may include a network interface or similar component in communication with nearby network towers. As a result, a location of the personal computing device 202 may be triangulated or otherwise determined using the nearby network towers.

Additionally, to facilitate communication between the personal computing device 202 and the geolocation processing server 204, the personal computing device 202 may include a geolocation processing software development kit (SDK) 214. The geolocation processing SDK 214 may be or may include a set of executable instructions, data libraries, code, or a combination therefore used to create a specific framework or communication language between the personal computing device 202 and the geolocation processing server 204. The geolocation processing SDK 214 may provide a set of functionalities and/or resources to integrate geolocation tracking into the personal computing device 202. For example, the geolocation processing SDK 214 may be integrated into the gambling application 212 or in communication with the gambling application 212 to facilitate communication between the personal computing device 202 and the geolocation processing server 204 to determine a location of the personal computing device 202.

It should be noted that the database 222 and the database 228 may store, manage, or otherwise provide data for executing software services and/or delivering such software services to the personal computing device 202. That is, the database 222 may store, manage, or otherwise provide data for executing the services 220 and/or delivering the services 220 to the personal computing device 202, and the database 228 may store, manage, or otherwise provide data for executing the services 226 and/or delivering the services 226 to the personal computing device 202.

In particular, the database 222 and the database 228 may implement one or more tables or other information sources suitable for use with a software application implemented using the geolocation processing server 204 and the gaming server 206. The database 222 and the database 228 may include a data storage unit accessible by software executed on the geolocation processing server 204 and/or the gaming server 206. The database 222 and/or the database 228 may be a relational database management system (RDBMS), an object database, an XML database, a configuration management database (CMDB), a management information base (MIB), one or more flat files, other suitable non-transient storage mechanisms, or a combination thereof.

In some implementations, the database 222 and/or the database 228, or portions thereof, may be stored, managed, or otherwise provided by other elements of the system 200 other than the geolocation processing server 204 and the gaming server 206. For example, the database 222 and/or the database 228, or portions thereof, may be stored, managed, or otherwise provided by the personal computing device 202.

Turning back to the geolocation processing server 204, the geolocation processing server 204 may also include one or more applications 218. The applications 218 may be similar to the applications 224 such that a service representative may access or otherwise interface with the services 220, the geolocation rules engine 216, and/or the database 222 of the geolocation processing server 204. Similarly, the applications 218 may also provide the service representative access to, or interface with, the services 226 and/or the database 228 of the gaming server 206.

The personal computing device 202, the geolocation processing server 204, and the gaming server 206 may be in communication via a network 208. The network 208 may be or may include, for example, the Internet, a local area network (LAN), a wide area network (WAN), a virtual private network (VPN), or another public or private means of electronic computer communication capable of transferring data between the personal computing device 202 and one or more servers (e.g., the geolocation processing server 204 and/or the gaming server 206). In some implementations, a user, via the personal computing device 202, may connect to the network 208 via a communal connection point, link, or path, or using a distinct connection point, link, or path. For example, a connection point, link, or path can be wired, wireless, use other communications technologies, or a combination thereof.

The network 208, the personal computing device 202, the geolocation processing server 204, the gaming server 206, another element of the system 200, or a combination of elements of the system 200, may include network hardware such as routers, switches, other network devices, or a combination thereof.

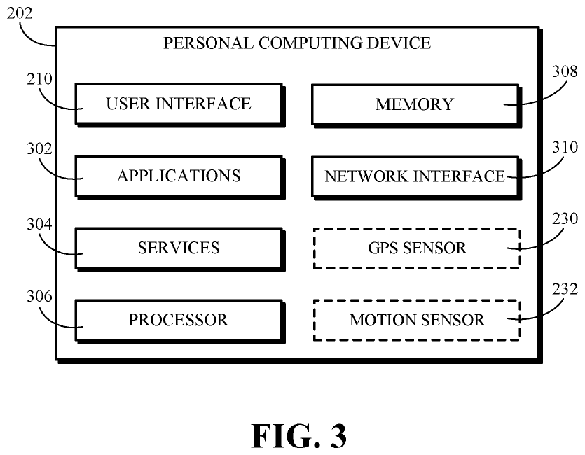

FIG. 3 is a block diagram of an example of an internal configuration of the personal computing device 202 of the system 200. As discussed above, the personal computing device 202 may be a mobile cellular device (e.g., the mobile cellular device 102), a laptop (e.g., the laptop 104), a desktop, a tablet, or a combination thereof.

The personal computing device 202 may include components or units, such as the user interface 210, the GPS sensor 230, the motion sensor 232, applications 302, services 304, a processor 306, a memory 308, a network interface 310, other suitable components, or a combination thereof. One or more of the user interface 210, the GPS sensor 230, the motion sensor 232, the applications 302, the services 304, the memory 308, and the network interface 310 may communicate with, or be executable by, the processor 306 (e.g., via one or more buses of the personal computing device 202).

The processor 306 may be a central processing unit, such as a microprocessor, and may include a single processor or multiple processors. The single processor or multiple processors may have a single processing core or multiple processing cores. Alternatively, the processor 306 may include another type of device, or multiple devices, no existing or hereafter developed, configured for manipulating or processing information. For example, the processor 306 may include multiple processors interconnected in one or more manners, including but not limited to, hardwired or networked (e.g., wirelessly networked). By way of example, the operations of the processor 306 may be distributed across multiple devices or units that may be coupled directly or across a local area or other suitable type of network. The processor 306 may also include a cache, or cache memory, for local storage of operating data or instructions.

The memory 308 may include one or more memory components, which may each be volatile memory or non-volatile memory. For example, the volatile memory of the memory 308 may be random access memory (RAM) (e.g., a DRAM module, such as DDR SDRAM) or another form of volatile memory. In another example, the non-volatile memory of the memory 308 may be a disk drive, a solid-state drive, flash memory, phase-change memory, or another form of non-volatile memory configured for persistent electronic information storage. The memory 308 may also include other types of devices, now existing or hereafter developed, configured for storing data or instructions for processing by the processor 306.

In some implementations, the memory 308 may be distributed across multiple devices. For example, the memory 308 may include network-based memory or memory in multiple clients or servers (e.g., the geolocation processing server 204 and/or the gaming server 206) performing the operations of those multiple devices.

The memory 308 can include data for immediate access by the processor 306. For example, the memory 308 may include executable instructions, application data, an operating system, or a combination thereof accessible by the processor 306. The executable instructions, the application data, the operating system, or a combination thereof may be loaded or copied, in whole or in part, from non-volatile memory to volatile memory to be executed by the processor 306. For example, the executable instructions and application data may include instructions and data for executing and running the applications 302 and/or the services 304. The applications 302 may be any application, such as the gambling application 212 described above. Similarly, the services 304 may be any services executed and run on the personal computing device 202.

The executable instructions and/or the application data may include user data, database data (e.g., database catalogs or dictionaries associated with or accessed from the database 222 and/or the database 228), or the like. In some implementations, the executable instructions and/or the application data may include functional programs, such as a web browser, a web server, a database server, another program, or a combination thereof.

In another example, the operating system may be accessed by the processor 306 to provide the user the user interface 210 to access the applications 302 (e.g., the gambling application 212). The operating system may be, for example, Microsoft Windows®, Mac OS X®, Linux®. Additionally, or alternatively, the operating system may be an operating system for a mobile device, such as a smartphone or table device (e.g., the mobile cellular device 102), including iOS®, Android®, or the like. Moreover, the operating system may be an operating system for a non-mobile device, such as a mainframe computer.

The user interface 210 may include one or more input interfaces and/or output interfaces. An input interface may be, for example, a positional input device, such as a mouse, touchpad, touchscreen, or the like; a keyboard; or another suitable human or machine interface device. An output interface may be, for example, a display, such as a liquid crystal display, a cathode-ray tube, a light emitting diode display, or other suitable display. Thus, the user may interact with the applications 302, such as the gambling application 212, via the user interface 210.

The network interface 310 may include software and/or hardware to provide a connection or link to a network (e.g., the network 208). The connection or link to a network may be wired or wireless. Via the network interface 310, the personal computing device 202 may communicate with other devices (e.g., the geolocation processing server 204 and/or the gaming server 206) using one or more network protocols, such as using Ethernet, transmission control protocol (TCP), internet protocol (IP), power line communication, an IEEE 802.X protocol (e.g., Wi-Fi, Bluetooth, ZigBee, etc.), infrared, visible light, general packet radio service (GPRS), global system for mobile communications (GSM), code-division multiple access (CDMA), Z-Wave, another protocol, or a combination thereof.

The network interface 310 may be or may include a radio frequency device or one or more radio frequency components. The network interface 310 may include, or be in communication with, the GPS sensor 230 and/or the motion sensor 232. As such, the network interface 310 may transmit and/or receive signals (e.g., radio frequency (RF) signals) to determine a location of the personal computing device 202. The network interface 310 may include one or more receivers, one or more antennas, one or more power amplifiers, or a combination thereof. The network interface 310 may be in communication with the processor 306 such that the processor 306 may execute one or more instructions for the network interface 310. For example, the network interface 310 may be configured for various frequency bands for mobile communications (e.g., GSM, CDMA, LTE, 5G) and the processor 306 may be configured to manage encoding, decoding, and communication protocols for the desired frequency bands.

Based on the above, the geolocation services described herein may determine a location of the personal computing device 202 using or communicating with the network interface 310 of the personal computing device 202. By way of example, a location of the personal computing device 202 may be determined using a global positioning system (GPS), an assisted global positioning system (A-GPS), cellular network tower triangulation, Wi-Fi positioning, Bluetooth signals and/or beacons configured for proximity-based location tracking, sensor data of one or more sensors of the personal computing device 202 (e.g., the GPS sensor 230, the motion sensor 232, or other sensors that may be or may include accelerometers, gyroscopes, or the like), network-based location services (e.g., network information, such as a location of a cellular network tower that the personal computing device 202 is connected to or an internet protocol (IP) address of the personal computing device 202 on the network), or a combination thereof. As such, the teachings herein are not particular limited to any one method of determining a location of the personal computing device 202.

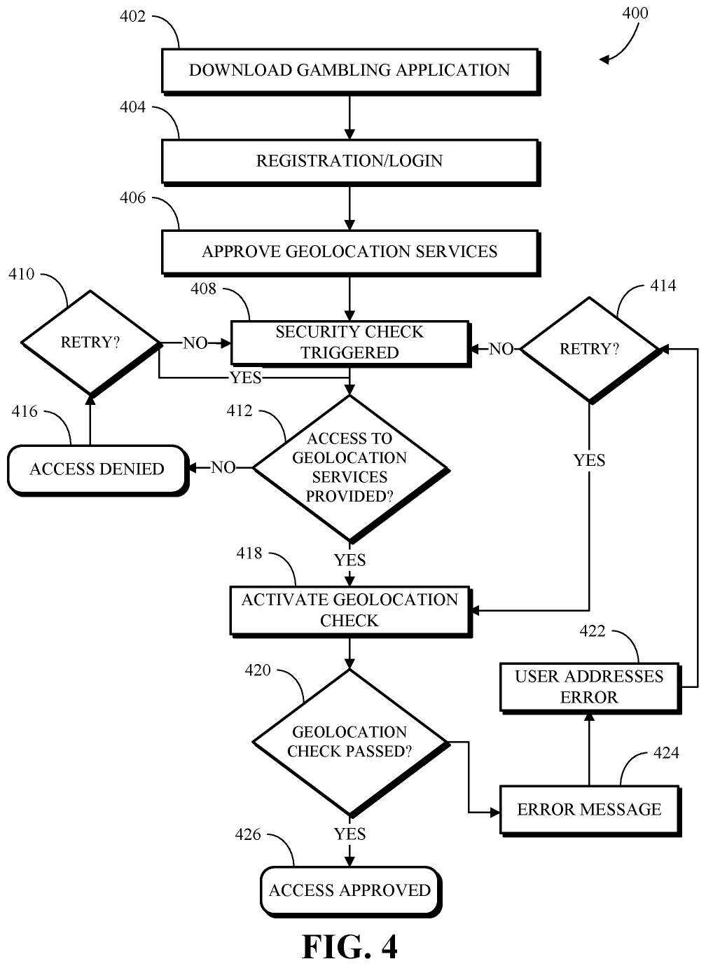

FIG. 4 is a flow diagram of an example of a process 400 for implementing geolocation services for an online gambling application. The process 400 for implementing the geolocation services may be used in any system, such as the system 200. As such, the process 400 may be completed by one or more devices, such as the personal computing device 202, the geolocation processing server 204, the gaming server 206, or a combination thereof. It should also be noted that, while the process 400 describes implementation for an online gambling application, the process 400 may be implemented to service any type of application and/or device.

The process 400 may include downloading a gambling application onto a personal computing device, such as the personal computing device 202, at operation 402. For illustrative purposes, the process 400 is described below in reference to the personal computing device 202 and the system 200.

At 402, a user may download the gambling application to store in memory of the personal computing device and execute using a processor of the personal computing device 202. For example, the gambling application at 402 may be the gambling application 212 stored in the memory 308 and executed using the processor 306 of the personal computing device 202. The gambling application may also be accessed free of downloading the application to the personal computing device. For example, the gambling application may be accessed through a web browser on the personal computing device 202 via the network 208.

Once the gambling application is downloaded at 402 or otherwise accessed, a user may register and log into the gambling application at 404. Registration may be required for new users while returning users may be prompted directly to log into the gambling application without registration. For example, each user may be required to initially input login credentials (e.g., username and password), credit card and/or bank information for gambling funds, an address, a birthdate, other information, or a combination thereof. Such user information may be tracked and/or stored locally on the personal computing device 202 and/or stored remotely on the geolocation processing server 204 and/or the gaming server 206.

After the user registers and/or logs into the gambling application at 404, it may be determined at 406 whether the user has approved geolocation tracking services for the personal computing device 202. That is, in order to permit initial access to the gambling application, the personal computing device 202 may be required to allow geolocation services to track a location of the personal computing device 202. All or a portion of the geolocation services may be implemented by the personal computing device 202, the geolocation processing server 204, the gaming server 206, or a combination thereof. For example, the gambling application may prompt the user to approve geolocation services for tracking a location of the personal computing device 202 before the user is permitted to use the gambling application.

Once geolocation services approval is permitted at 406, a user may be able to access additional portions of the gambling application. However, an additional security check may be triggered at 408 prior to the user managing gambling funds and/or commencing in gambling through the gambling application. The security check at 408 may evaluate one or more parameters to determine whether the user may proceed with checking gambling funds and/or commencing in gambling through the gambling application. For example, the security check at 408 may determine whether the user is of a sufficient age to gamble and/or whether the credit card information or bank information initially provided is valid.

The security check at 408 may also evaluate overall device integrity of the personal computing device 202 and identify prohibited software that may conflict with authorized use of the gambling application.

With respect to device integrity of the personal computing device 202, the security check at 408 may evaluate whether the personal computing device 202 is jailbroken (e.g., removing software restrictions originally imposed by the operating system of the personal computing device 202) or rooted. Such jailbreaking or rooting of the personal computing device 202 may facilitate spoofing of geolocation data associated with the personal computing device 202. As a result, the spoofed geolocation data may inaccurately locate the personal computing device 202 in an approved location even though the personal computing device 202 may be physically located in an unauthorized location. Thus, the security check at 408 and/or another step in the process 400 may analyze whether the personal computing device 202 is accurately providing geolocation data. If such geolocation data is spoofed due to jailbreaking and/or rooting of the personal computing device 202, geolocation services and use of the gambling application may be denied.

Similarly, the security check at 408 and/or another step of the process 400 may determine whether any software of the personal computing device 202 could be used to falsify geolocation data and/or circumvent geolocation checks of the process 400. For example, such prohibited software may include, but is not limited to, location spoofing software, remote desktop applications, virtualization (e.g., a virtual private network (VPN)), software that may compromise use of the gambling application, the like, or a combination thereof. Thus, the security check at 408 and/or another step in the process 400 may analyze whether prohibited software is present on the personal computing device 202. If such prohibited software is present, geolocation services and use of the gambling application may be denied.

The security check at 408 may also prompt reevaluation of whether geolocation services have been permitted for the personal computing device 202 at 412. For example, a user may be asked at 406 to approve geolocation services yet may deny such approval and still be permitted to access a home screen of the gambling application. However, when the user attempts to access their gambling funds or tries to place a bet, the security check at 408 may prompt a reevaluation at 412 to confirm if geolocation services have been approved.

If it is determined at 412 that geolocation services have still not been permitted by the user, access to the gambling application may be denied at 416. For example, the user may be restricted from managing their gambling funds or placing a bet at 416. The gambling application may display a message to the user to indicate that access has been restricted due to denying geolocation services.

Once access is denied at 416, a user may be prompted at 410 to retry determining whether access to geolocation services has been approved at 412. For example, a prompt may be displayed on a display of the personal computing device 202 at 410 to ask the user whether to retry determining whether access to geolocation services has been approved. If the user selects “yes,” the determination may once again be completed at 412. However, if the user selects “no” and does not wish to retry determining approval of geolocation services, the user may be given access to a main screen of the gambling application for basic access. Therefore, when the user tries again to manage gambling funds or place a bet, another security check at 408 may once be triggered.

It should be noted that the determination at 412 may deny access for reasons other than the user denying geolocation services. For example, a firewall or security protocol of the personal computing device 202 may be configured to deny such geolocation services such that, even if the user were to approve access for the gambling application, the personal computing device 202 may still block the location request. In such a case, access may be denied at 416 until the firewall or security protocol is modified to permit access for geolocation services.

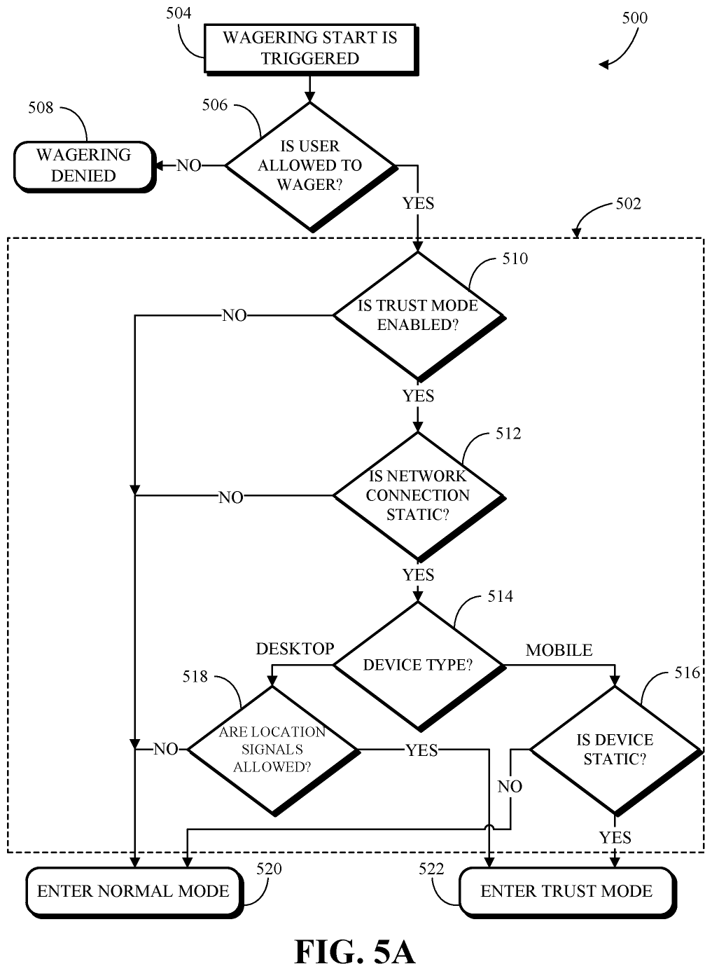

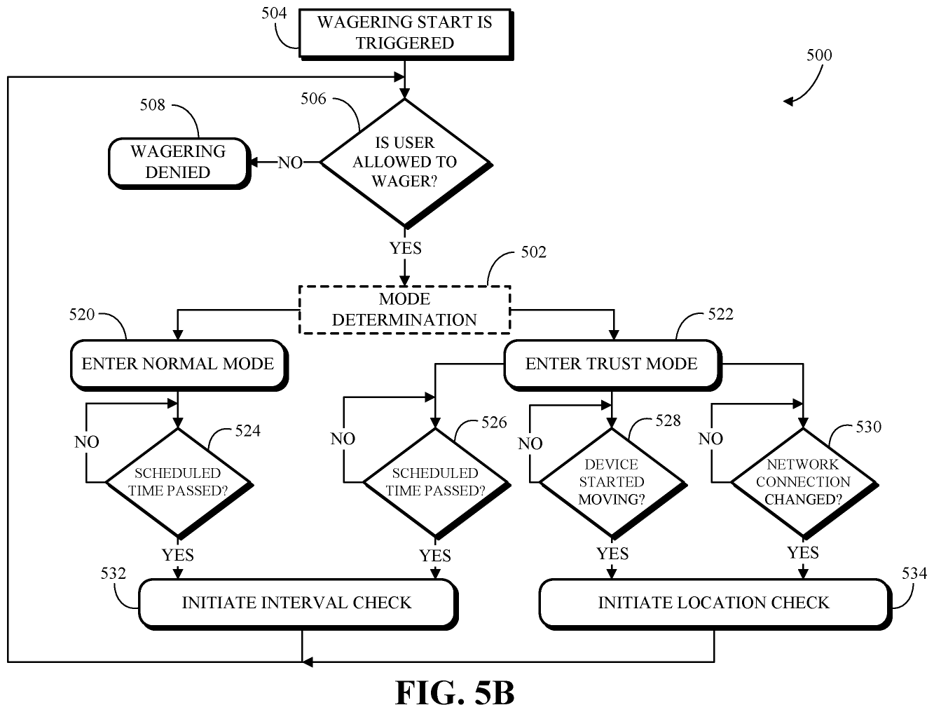

Once access to geolocation services is determined to be permitted at 412, the geolocation services may be activated to determine a location of the personal computing device 202 at 418. The location of the personal computing device 202 may be determined at 418 to evaluate whether the user is permitted to gamble using the gambling application in their current location. As mentioned above, such a geolocation check may be completed based on a predefined time interval based on legislation or other requirements for using the gambling application. However, as described below with respect to FIGS. 5A and 5B, such a time interval may be dynamically adjusted using the geolocation services described herein.

After the geolocation check is activated at 418 to determine a location of the personal computing device 202, it may be determined whether the geolocation check is approved at 420. That is, at 420, the location of the personal computing device 202 may be evaluated using one or more parameters to determine if the location of the personal computing device 202 is within an approved region for gambling using the gambling application (e.g., an approved state, an approved country, an approved jurisdiction, etc.). By way of example, the one or more parameters may include evaluating whether a location of the personal computing device 202 is within an approved state for gambling.

Such parameters may utilize data stored on the geolocation processing server 204 and/or the gaming server 206. For example, the location of the personal computing device 202 may be determined using an IP address of the personal computing device 202. The IP address of the personal computing device 202 may be transmitted to the geolocation processing server 204 to cross-reference the IP address of the personal computing device 202 with a list of approved IP addresses stored in the database 222 of the geolocation processing server 204.

If the location of the personal computing device 202 passes evaluation at 420, access is approved at 426 and the user may be permitted to use the gambling application to manage gambling funds, place bets, or otherwise partake in gambling. It should be noted that, based on the established time interval described above, activation at 418 and evaluation at 420 may be completed any number of times during use of the gambling application to continue to monitor that the personal computing device 202 is still within an approved location for gambling.

If the location of the personal computing device 202 does not pass evaluation at 420, an error message may be displayed for the user at 424. The error message may be displayed on the personal computing device 202 to notify the user that gambling through the gambling application is not permitted at the current location of the personal computing device 202. The error message at 424 may also provide additional information to the user if an operational error occurs during the geolocation check. For example, if a network connection of the personal computing device 202 is intermittent or otherwise inconsistent such that a location of the personal computing device 202 cannot be accurately determined, the error message 424 may notify the user of the poor network connection.

Based on the error message at 424, the user may address the error at 422. For example, the user may change their location to a permitted location or, in the case of a poor network connection, may improve their connection. Once the user addresses the error at 422, the user may be prompted at 414 to retry the geolocation check. The request for retrying the geolocation check may be similar to the retry prompt at 410. If the user approves the retrial at 414, the geolocation services may be once again activated at 418 to determine a location of the personal computing device 202. If the user rejects retrial at 414, the user may be given access to a main screen of the gambling application for basic access. Therefore, when the user tries again to manage gambling funds or place a bet, another security check at 408 may once be triggered.

FIG. 5A is a flow diagram of an example of a process 500 for implementing geolocation services for online gambling. FIG. 5B is a continuation of the flow diagram of FIG. 5A to further illustrate the process 500 for implementing geolocation services for online gambling. The process 500 for implementing the geolocation services may be used in any system, such as the system 200. As such, the process 500 may be completed by one or more devices, such as the personal computing device 202, the geolocation processing server 204, the gaming server 206, or a combination thereof. It should also be noted that, while the process 500 describes implementation for an online gambling application, the process 500 may be implemented to service any type or application and/or device.

The process 500 may also be used in conjunction with the process 400 described above. For example, the geolocation services described with respect to the process 500 may be implemented to determine a location of the personal computing device 202 based on operations 418 and 420 of the process 400. Similarly, the process 500 may be implemented during use of the gambling application to dynamically determine a time interval for checking the location of the personal computing device 202.

As described above, a user of the gambling application may be given initial approval for access to the gambling application based on the process 400. In a similar manner in accordance with the process 500, a user may initiate wagering or partake in gambling at 504. Based on such action by the user, the process 500 may determine at 506 whether the user is allowed to place the wager or partake in gambling through the gambling application. Such a determination may be based on an initial location of the personal computing device 202, such as described with respect to implementing the process 400.

By way of example, the user may begin wagering or gambling at 504, thereby triggering a determination at 506 to determine whether the gambling by the user is permitted. A location of the personal computing device 202 may be used to evaluate whether the location of the personal computing device 202 is located within an approved region, such as within a state and/or jurisdiction that permits online gambling in accordance with laws of the state. If the personal computing device 202, and thus the user, are not located within an approved region, wagering and/or gambling is denied at 508. Alternatively, if the personal computing device 202, and thus the user, are located within an approved region, the process 500 may implement a mode determination 502 portion of the process 500.

As discussed above, a location of the personal computing device 202 may be checked based on a set time interval. The time interval established may be based on state legislation or other requirements pertaining to a given location of the personal computing device 202. Such a time interval may conventionally be shorter when the personal computing device 202 is located closer to regions (e.g., states) that do not permit online gambling through the gambling application, such as when the personal computing device 202 is located near a state border.

As a result, conventional geolocation services may more frequently communicate with the personal computing device 202 of a user located near a border of an approved region, thereby requiring additional computing power and resources of the personal computing device 202. In circumstances where the user lives near the border of the approved region or is otherwise in a stationary location near the border of the approved region, the above conventional geolocation services may hinder the user experience compared to a user located more centrally within the approved region.

To combat the above difficulties, the mode determination 502 may dynamically evaluate the location of the personal computing device 202 to adjust the time interval for checking the location of the personal computing device 202. The mode determination 502 may be configured to select one or more modes of the geolocation services, such as a normal mode and a trust mode.

The normal mode of the geolocation services may operate according to conventional time intervals as described above. The normal mode of the geolocation services may be implemented when, for example, the personal computing device 202 or a network connection thereof is moving, or when a location of the personal computing device 202 cannot be accurately determined relative to a neighboring territory which restricts online gambling through the gambling application. Thus, in circumstances where the personal computing device 202 may be actively moving (e.g., a user in a vehicle), the geolocation services may operate in the normal mode to check the location of the personal computing device 202 more frequently.

Alternatively, the trust mode of the geolocation services may be implemented when, for example, the personal computing device 202 or a network connection thereof is static (e.g., stationary), even if the personal computing device 202 is located near a neighboring territory which restricts online gambling through the gambling application. In such circumstances, the geolocation services may operate in the trust mode to check the location of the personal computing device 202.

In the trust mode, the geolocation services may operate to check the location of the personal computing device 202 at a frequency similar to if the geolocation services were operating in the normal mode. However, in the trust mode, the geolocation services may operate free of any additional requirements (e.g., extra location checks, decreased time interval between location checks, or other security measures, etc.) that may be required in the normal mode when the personal computing device 202 is located near a border or restricted region, such as those described above. That is, in the trust mode, the geolocation services may operate to check the location of the personal computing device 202 at a frequency similar to if the geolocation services were operating in the normal mode and the personal computing device 202 was not near a border or restricted region.

Referring now to the process 500, if it is determined at 506 that a wager and/or other gambling is allowed, a determination at 510 may evaluate whether trust mode is enabled for a current location of the personal computing device 202. That is, the personal computing device 202 may be located in an approved region, such as an approved state, for gambling through the gambling application. In such a case, the determination at 510 may evaluate whether the approved state permits trust mode to be enabled based on the present teachings. That is, the determination at 510 may evaluate whether the approved state permits dynamically adjusting the time interval for checking the location of the personal computing device 202.

If trust mode is not approved for the present location of the personal computing device 202, the geolocation services may implement normal mode at 520, as described above, whereby a time interval for checking the location of the personal computing device 202 may be based on conventional requirements. Alternatively, if trust mode is approved for the present location of the personal computing device 202, the process 500 may progress to 512 to determine whether a network connection of the personal computing device 202 is static.

The determination at 512 may be based on one or more conditions of the network connection. By way of example, the network connection may be considered static if an internet protocol (IP) address of the network (e.g., a network address, subnet address, or the like) is categorized as a residential or business IP address, if the IP address of the network is not a mobile address, if the IP address of the network is not categorized as a wireless within an internal database (e.g., the IP address of the network is not on an approved IP list stored on the database 222 of the geolocation processing server 204), or a combination thereof. For example, in some implementations, all of the above conditions must be met to determine at 512 that the network connection is static. If the network connection is determined to not be static at 512, the geolocation services may implement the normal mode at 520 as described above.

If the network connection is determined to be static at 512, the process 500 may progress to 514 to determine a device type. In particular, it may be determined at 514 whether the personal computing device 202 is a desktop computing device) or a mobile computing device (e.g., a smartphone). Such a determination may be based on information provided by the personal computing device 202 to the geolocation processing server 204.

If the device type is determined to be a mobile device at 514, the process 500 may progress to 516 to determine whether the personal computing device 516 is static. That is, it may be determined at 516 whether the personal computing device 202 is physically moving or stationary. Such a determination may be based on movement (e.g., speed) data provided by the personal computing device 202. For example, the personal computing device 202 may include an accelerometer and/or a gyroscope that may monitor movement of the personal computing device 202 and provide such information for the geolocation services.

Additionally, such a determination may be based one or more predictive models established to predict movement of the personal computing device 202 based on information other than the movement data provided by the personal computing device 202. The predictive models may be stored on and/or executed by the personal computing device 202 or one or more additional devices, such as the geolocation processing server 204.

If the personal computing device 202 is determined to be static at 516, the geolocation services may implement the trust mode at 522, at which point the time interval for checking a location of the personal computing device 202 may be dynamically adjusted (e.g., increased) to improve the overall user experience of the gambling application and decrease location checking of the personal computing device 202. Alternatively, if the personal computing device 202 is determined to not be static at 516—that is, the personal computing device 202 is moving—the geolocation services may implement the normal mode at 520.

Referring back to 514, if the device type of the personal computing device 202 is determined to be a desktop device, the process 500 may progress to 518 to determine whether sources of location signals of the personal computing device 202 are from an approved location for wagering and/or other forms of gambling through the gambling application. That is, location signals of the personal computing device 202 that may be used to determine a location of the geographical location of the personal computing device 202 may be evaluated to confirm that the personal computing device 202 is located within an approved region for wagering and/or other forms of gambling through the gambling application.

Such location signals may be data from the personal computing device 202 pertaining to a global positioning system (GPS), Wi-Fi network information, Bluetooth signals and/or beacons, sensor data, the like, or a combination thereof. All or a portion of the location signals provided by or associated with the personal computing device 202 may be required to be within the approved region. For example, in some implementations, all location signals may be required to indicate that the location of the personal computing device 202 is within an approved region.

If the location signals indicate at 518 that the personal computing device 202 is located within an approved region, the geolocation services may implement the trust mode at 522. Alternatively, if the location signals indicated at 518 that the personal computing device 202 is not located within an approved region, the geolocation services may implement the normal mode at 520.

FIG. 5B illustrates a continuation of the process 500 for implementing geolocation services for online gambling in accordance with the present disclosure. As discussed above wagering or initiation of gambling may commence at 504, at which point a determination at 506 may be done to determine whether the user is allowed to wager or initiate gambling. If the user is not allowed to wager or gambling, the wagering and gambling will be denied at 508. If the user is allowed to wager and gamble, the process 500 may progress to the mode determination 502 at described above to determine whether the geolocation services may implement the trust mode at 522 or the normal mode at 520. The mode determination 502 includes the steps described above with respect to 510-518.

If the geolocation services implement the normal mode at 520, a continuous evaluation may be completed at 524 based on a schedule time interval to determine whether a scheduled duration of time has passed. For example, the evaluation at 524 may be completed at a set evaluation time interval to determine whether the geolocation check time interval has passed. The geolocation check time interval may correspond to a duration of time established between location checks of the personal computing device 202, as described above. Therefore, the evaluation at 524 may be completed at a set evaluation time interval that is equal to or less than the geolocation check time interval to ensure that a time between location checks of the personal computing device 202 is not greater than the permitted duration of time.

If the scheduled time has not passed—that is, the duration of time between location checks of the personal computing device 202 has not elapsed—evaluation at 524 may continue based on a pre-defined interval. Alternatively, if the schedule time has passed—that is, the duration of time between location checks of the personal computing device 202 has elapsed—a geolocation check based on the geolocation check time interval may commence at 532. The initiated check at 532 may restart the process at 506 to determine if the user is allowed to wager or gamble based on the location of the personal computing device 202.

If the geolocation services implement the trust mode at 522, one or more conditions may be evaluated to determine when a location check at 534 is necessary. For example, once trust mode is implemented at 522, it may be determined whether a scheduled time has passed at 526 (e.g., similar to the determination at 524 in the normal mode), whether the device has physically started moving at 528 and/or whether a network connection has changed at 530. Movement of the device may be determined at 528 based on the conditions described above with respect to the determination at 516 (e.g., personal computing device 202 data, network data, etc.).

The evaluation at 526 may be completed at a set evaluation time to determine whether the geolocation check time interval has passed. The geolocation check time interval at 526 may be the same or different than the geolocation check time interval at 524. The geolocation check time interval at 526 may correspond to a duration of time established between location checks of the personal computing device 202, as described above. Therefore, the evaluation at 526 may be completed at a set evaluation time interval that is equal to or less than the geolocation check time interval to ensure that a time between location checks of the personal computing device 202 is not greater than the permitted duration of time. It should be note that the same or a similar set evaluation time interval may also be implemented for the evaluations at 528 and/or 530.

A network connection change determined at 530 may include any change in network conditions that may indicate movement of the personal computing device 202. For example, the personal computing device 202 may disconnect from Wi-Fi within a house when the user enters their car to drive to another location. As a result, the network connection may change from the Wi-Fi network to a cellular network. Based on such changes, it may be determined at 530 that a location check at 534 is warranted.

If it is determined that the personal computing device 202 is moving at 528 or it is determined that the network connection has changed at 530, the location check of the personal computing device 202 may be initiated at 534. Alternatively, if no movement or network change is determined at 528 and 530, respectively, the evaluation at 528 and 530 may continue until such changes occur. The evaluation at 528 and 530 may continue based on a predefined time interval between checks or may be based on one or more triggers (e.g., the evaluation may automatically be triggered by movement of the personal computing device 202. The location check initiated at 534 may restart the process at 506 to determine if the user is allowed to wager or gamble based on the location of the personal computing device 202.

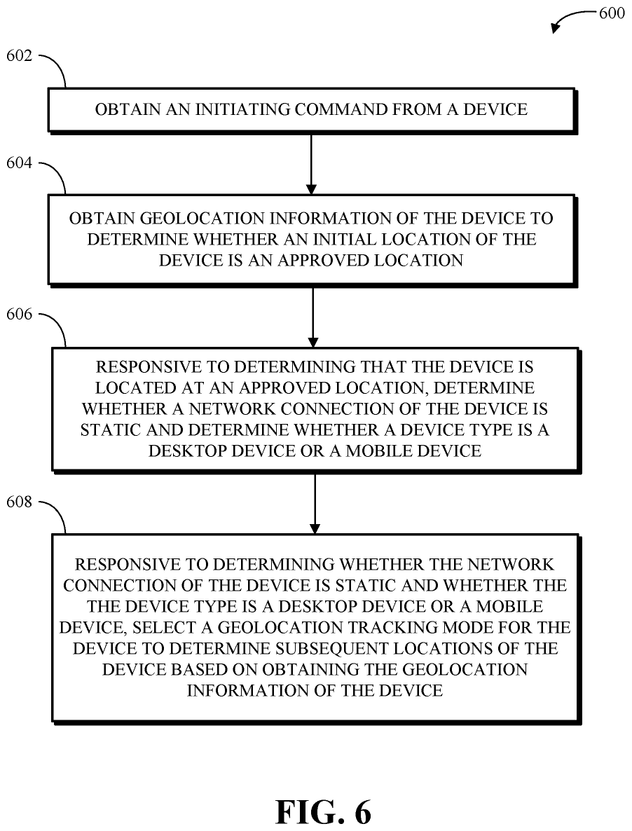

FIG. 6 is a flow diagram of an example of a method 600 for implementing geolocation services for online gambling. The method 600 may be executed using one or more computing devices, such as the systems, hardware, and software described with respect to FIGS. 1-5, including the personal computing device 202, the geolocation processing server 204, the gaming server 206, or a combination thereof. The method 600 may be performed, for example, by executing a machine-readable program or other computer-executable instructions, such as routines, instructions, programs, or other code. The steps, or operations, of the method 600 or another technique, method, process, or algorithm described in connection with the other implementations disclosed herein may be implemented directly in hardware, firmware, software executed by hardware, circuitry, or a combination thereof.

As shown in FIG. 6, the method 600 includes obtaining an initiating command from a device at 602, such as the personal computing device 202 or any other device. The initiating command may be an action taken by a user on the personal computing device 202, such as an action within the gambling application 212 (e.g., attempting to submit a bet, attempting to manage betting funds, etc.) The method 600 also includes obtaining geolocation information of the device at 604 to determine whether an initial location of the device is an approved location. Responsive to determining that the device is located at an approved location, the method 600 includes determining at 606 whether a network connection of the device is static and whether a device type is a desktop device or a mobile device. Responsive to determining whether the network connection of the device is static and whether the device type is a desktop device or a mobile device, the method 600 also includes selecting at 608 a geolocation tracking mode for the device to determine subsequent locations of the device based on obtaining the geolocation information of the device.

For simplicity of explanation, the method 600 is depicted and described herein as a series of steps or operations. However, the steps or operations in accordance with this disclosure may occur in various orders and/or concurrently. Additionally, other steps or operations not presented and described herein may be used. Furthermore, not all illustrated steps or operations may be required to implement a technique in accordance with the disclosed subject matter.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°+25% (e.g., an angle that lies within the range of (approximately) 135° to (approximately)) 225°. The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A method for geolocation monitoring, comprising:
obtaining an initiating command from a device;
obtaining geolocation information of the device to determine whether an initial location of the device is an approved location;
responsive to determining that the device is located at an approved location:
determining whether a network connection of the device is static; and
determining whether a device type is a desktop device or a mobile device; and
responsive to determining whether the network connection of the device is static and whether the device type is a desktop device or a mobile device, selecting a geolocation tracking mode for the device to determine subsequent locations of the device based on obtaining the geolocation information of the device.

2. The method of claim 1, wherein the geolocation tracking mode establishes a time interval for determining the subsequent locations of the device, the geolocation tracking mode is a trust mode or a normal mode, and the time interval established in the trust mode is equal to or longer than the time interval established in the normal mode.

3. The method of claim 2, further comprising:
responsive to determining that the initial location of the device is located at an approved location, determining whether the trust mode is enabled for a region in which the device is located.

4. The method of claim 2, further comprising:
responsive to determining that the network connection of the device is static and the device type is a mobile device, selecting the trust mode to determine the subsequent locations of the device.

5. The method of claim 4, further comprising:
responsive to determining that the network connection is not static, selecting the normal mode to determine the subsequent locations of the device.

6. The method of claim 1, wherein determining whether the network connection of the device is static includes:
determining whether an internet protocol (IP) address of the device is residential or business; and
determining whether the IP address of the device is mobile.

7. The method of claim 6, wherein determining whether the network connection of the device is static further includes obtaining, from a database, whether the IP address of the device is categorized as a wireless IP address.

8. The method of claim 1, further comprising:
responsive to determining that the device type is a mobile device, determining whether the device is static.

9. The method of claim 8, wherein determining whether the device is static is based on speed data from the device.

10. The method of claim 1, further comprising:
responsive to determining that the device type is a desktop device, determining whether location signals of the device are from an approved location.

11. The method of claim 10, wherein the location signals of the device include at least one of an IP address of the device, Wi-Fi network information of the device, and other location-related information provided by the device.

12. A system, comprising:
a device configured to provide access of an online gambling application to a user; and
a geolocation processing server configured to:
obtain an initiating command from the device;
obtain geolocation information of the device to determine whether an initial location of the device is located at an approved location;
responsive to determining that the device is located at an approved location:
determine whether a network connection of the device is static; and
determine whether a device type is a desktop device or a mobile device; and
responsive to determining whether the network connection of the device is static and whether the device type is a desktop device or a mobile device, establish a time interval to determine subsequent locations of the device based on obtaining the geolocation information of the device.

13. The system of claim 12, wherein the geolocation processing server is further configured to:
responsive to determining that the device is not located at an approved location, deny permission of the user to access the online gambling application.

14. The system of claim 12, wherein the geolocation processing server is further configured to:
responsive to determining that the network connection of the device is static and the device type is a mobile device, determine whether the device is static based on speed data obtained from the device; and
responsive to determining that the device is static, establish the time interval to determine subsequent locations of the device such that the time interval established is greater than a time interval established when the device is not static.

15. The system of claim 12, wherein the geolocation processing server is further configured to:
responsive to determining that the network connection of the device is static and the device type is a desktop device, determine whether location signals of the device are from an approved location; and
responsive to determining that the location signals of the device are from an approved location, establish the time interval to determine subsequent locations of the device such that the time interval established is greater than a time interval established when the location signals of the device are not from an approved location.

16. The system of claim 12, wherein the geolocation processing server is further configured to:
modify the time interval established based on one or more conditions, wherein the one or more conditions includes at least one of:
the network connection of the device changes;
the device moves; and
a scheduled time period passes for reevaluation of the time interval.

17. A method for determining operation of an online gambling application using geolocation information of a device, comprising:
obtaining, from the device, an initiating command that corresponds to a user interaction with the online gambling application via a user interface of the device;
obtaining geolocation information of the device to determine whether an initial location of the device is within an approved region for use of the online gambling application;
responsive to determining that the initial location of the device is within the approved region:
determining whether a network connection of the device is static; and
determining whether a device type is a desktop device or a mobile device; and
selecting a geolocation tracking mode for the device based on the network connection of the device and the device type, wherein the geolocation tracking mode establishes a time interval for determining subsequent locations of the device based on obtaining the geolocation information of the device.

18. The method of claim 17, further comprising:
responsive to determining that the network connection of the device is static and the device type is a mobile device, determining whether the device is static based on speed data obtained from the device.

19. The method of claim 18, further comprising:
responsive to determining that the network connection of the device is static and the device type is a desktop device, determining whether location signals of the device are from an approved location, wherein the location signals of the device include at least one of an IP address of the device, Wi-Fi network information of the device, and other location-related information provided by the device.

20. The method of claim 19, wherein the geolocation tracking mode is a trust mode or a normal mode, and the time interval established in the trust mode is equal to or longer than the time interval established in the normal mode; and
wherein the method further comprises:
responsive to determining that the initial location of the device is within the approved region for use of the online gambling application, determining whether the trust mode is enabled for the approved region.
